(19) United States
(12) Patent Application Publication
(10) Pub. No.: US 2010/0311506 A1
(43) Pub. Date: Dec. 9, 2010

(54) METHOD AND SYSTEM FOR RE-CONNECTING AN UNEXPECTEDLY OFF-LINE WEB-GAME

(75) Inventor: Yongjie Bai, Xi'an (CN)

Correspondence Address: J C PATENTS, 4 VENTURE, SUITE 250, IRVINE, CA, 92618, US

(73) Assignee: INVENTEC APPLIANCES CORP., Taipei (TW)

(21) Appl. No.: 12/796,929

(22) Filed: Jun. 9, 2010

(30) Foreign Application Priority Data
Jun. 9, 2009 (TW) 98119227

(51) Int. Cl. A63F 13/12; A63F 13/00

(52) U.S. Cl. 463/42; 463/43

(57) ABSTRACT

A method and system for re-connecting an unintentionally off-line web-game is disclosed. The system comprises a user electronic device, a web, and a web-game server. When the user electronic device unexpectedly withdraws from the web-game because of communicated-disruption of the web, the web-game server continues the web-game immediately in accordance with the highest benefit of the user. After the user electronic device re-logs into the web-game server, the web-game sever permits the user electronic device to continue the web-game if the user electronic device is unexpectedly withdrawn from the web-game for less than a timeout threshold.

### CROSS-REFERENCE TO RELATED APPLICATION

This application claims the priority benefit of Taiwan application serial no. 98119227, filed on Jun. 9, 2009. The entirety of the above-mentioned patent application is hereby incorporated by reference herein and made a part of specification.

### BACKGROUND OF THE INVENTION

1. Field of the Invention

The present invention relates to a system and a method for re-connecting a web. More particularly, the present invention relates to a system and a method for re-connecting an unexpectedly off-line web-game.

2. Description of Related Art

Along with the information revolution, human society is gradually shifted from the industrial era into the information era, and the rapid development network systems in recent years are the most obvious example. With widespread of web patterns such as the Internet etc., a variety of web-related industries have begun to popularize. Moreover, due to a mass production of personal computers (PCs), a current global PC popularity rate reaches 13.5%. In addition, Taiwan's Internet popularity rate is as high as 58.4%, ranking the fourth Asia-Pacific. Accordingly, in collaboration with the network communication, game practitioners have developed game types different from the past, by which a player can connect a personal electronic device to a web-game server to play a web-game with other players, and the web-games includes online games and web-page games. Different to the past, one player can play the web-game with the other players through a local area network (LAN) connection, and such technology can significantly enhance game interesting and game challenge.

However, unstable web connection can cause unintentional disruption of the web-game played by the player, and in this case, conventionally, the computer can take over the web-game until the end of the game, so as to ensure the other web-game players continually and normally playing such game. However, account points of the off-line player are still counted. Presently, it is required to purchase account points in order to play the commonly available web-games in the market, and a player probably has to spend a long time on the web-game to gain considerable experience or obtain treasure items in the web-game, though the unintentional disruption of the web-game can cause an instant disappearance of the long-time accumulated intangible assets. Moreover, some players even spend money to play the web-game at a network center which can provide a high-speed Internet access, though it still can not completely avoid a loss of the game player caused by the web-game disruption.

Therefore, the web-game disruption caused by the unstable web connection can probably lead to a loss of money and the intangible assets, so that it is important to lower the loss of the player caused by the web disruption.

### SUMMARY OF THE INVENTION

### Technical Problems to be Resolved and Objectives of the Present Invention

In the conventional technique, when a player is unexpectedly withdrawn from a web-game due to unstable web connection, although a web-game server can take over the web-game until the end of the game, the player's benefit is not considered, which may cause a loss of money and intangible assets. The present invention provides a technique for re-connecting an unexpectedly off-line web-game, by which when the player is unexpectedly withdrawn from the web-game due to the unstable web connection, and if the player is reconnected within a timeout threshold, the player is permitted to continue the web-game.

### Technical Means for Resolving the Above Problems

The present invention provides a system for re-connecting an unexpectedly off-line web-game to resolve the problems of the conventional technique. The system comprises a user electronic device, a web, a transition apparatus and a web-game server. When a user operates the user electronic device to connect the web-game server through the web, and the user electronic device is unexpectedly withdrawn from the web-game because of an unstable web connection, the web-game server continues the web-game immediately in accordance with the highest benefit of the user. After the user electronic device is successfully reconnected, the web-game sever determines whether the user intentionally disrupts the web-game and whether the user logs out the web-game approaches a timeout threshold, so as to determine whether or not permits the user to continue the web-game.

Technical functions of the present invention compared to that of the conventional technique:
Compared to the conventional technique for re-connecting the off-line web-game, in the present invention, the web-game server takes over the web-game disrupted due to the unstable web connection in accordance with the highest benefit of the user. After the user electronic device is successfully reconnected, the web-game sever permits the user electronic device to continue the web-game when determining that the user electronic device is reconnected to the web-game within a timeout threshold, and the user electronic device is unexpectedly withdrawn from the web-game. According to the above method, the loss of money and intangible assets caused by the unstable web connection can be greatly reduced, so as to protect the user's right and interest.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an embodiment of the present invention.

FIG. 2 is a schematic diagram illustrating a game widow provided to a user for logging in and operating a web-game according to an embodiment of the present invention.

FIG. 3A is a simple flowchart illustrating an implementation method of the present invention.

FIG. 3B is a flowchart illustrating follow-up steps of an implementation method of the present invention of FIG. 3A.

### DESCRIPTION OF THE EMBODIMENTS

According to a system and a method for re-connecting an unexpectedly off-line web-game of the present invention, a web-game server is used to continue the web-game in accordance with the highest benefit of the user when a user is unexpectedly withdrawn from the web-game because of unstable web connection. When the user is successfully reconnected, the web-game server permits the user to continue the web-game when determining that the user is unexpectedly withdrawn from the web-game, and reconnects the web-game within a timeout threshold. The related combinations and implementations of the present invention are numerous, and therefore detailed descriptions thereof are omitted, and only one exemplary embodiment is provided below for detailed description.

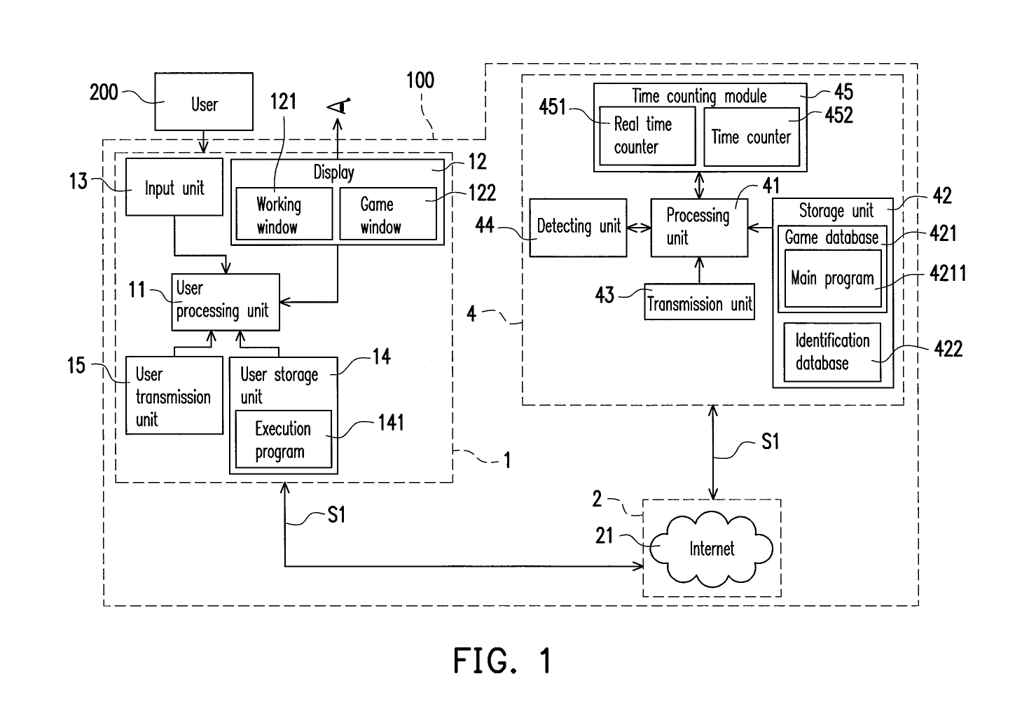

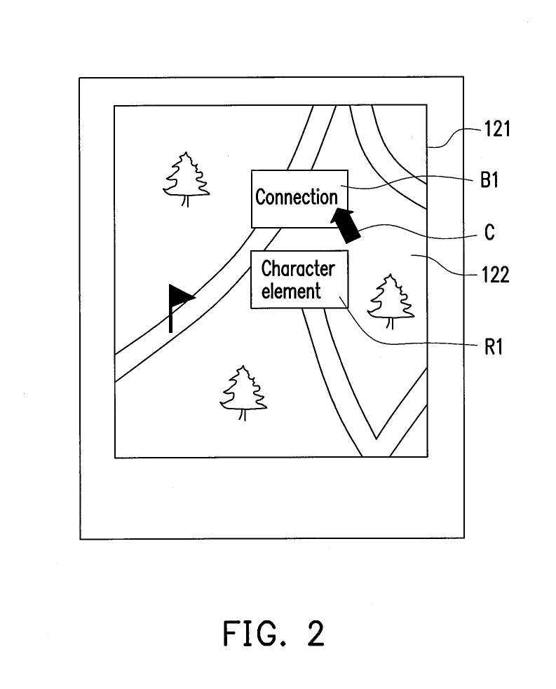

An exemplary embodiment of the present invention is described below with reference of figures. Referring to FIG. 1 and FIG. 2, FIG. 1 is a functional block diagram of an embodiment of the present invention. FIG. 2 is a schematic diagram illustrating a game widow provided to a user for logging in and operating the web-game according to an embodiment of the present invention. As shown in figures, in a system for re-connecting an unexpectedly off-line web-game 100, a user 200 operates a user electronic device 1 to communicate with a web-game server 4 through a web 2.

The user electronic device 1 includes a user processing unit 11, a display 12, an input unit 13, a user storage unit 14 and a user transmission unit 15. Wherein, the display 12, the input unit 13, the user storage unit 14 and the user transmission unit 15 are electrically connected to the user processing unit 11, respectively. The user storage unit 14 further includes at least one execution program 141, which can be provided to the user 200 to execute a web-game.

The web-game server 4 includes a processing unit 41, a storage unit 42, a transmission unit 43, a detecting unit 44 and a time counting module 45. Wherein, the storage unit 42, the transmission unit 43, the detecting unit 44 and the time counting module 45 are electrically connected to the processing unit 41, respectively. The storage unit 42 further includes a game database 421 and an identification database 422. The game data 421 stores at least one main program of a web-game (e.g. the main program 4211), and the main program 4211 includes at least one character element R1. The time counting module 45 further includes a real time counter (RTC) 451 and a time counter 452. The RTC 451 is used for recording a time when the user 200 is disrupted from the web-game server 4, and the time counter 452 is for counting an accumulated disruption time.

In order to implement the technique disclosed by the embodiment of the present invention, the user transmission unit 15 and the transmission unit 43 have to be first connected to the web 2 through a cable or wireless approach, wherein the web 2 is the Internet 21. The user 200 operates the input unit 13 to display a working window 121 on the display 12, and then operates the input unit 13 to activate a web-game, so as to display a game window 122 on the display 12.

In the present embodiment, preferably, the user 200 can install the execution program 141 or open a browser in the user electronic device 1 to activate the web-game.

Referring to FIG. 1 and FIG. 2, the user 200 controls a cursor C through the input unit 13 to select a game connection button B1, so as to generate a game connection signal S1 (as shown in FIG. 1). Now, the game connection signal S1 is transmitted to the web-game server 4 through the user transmission unit 15 and the Internet 21. After the web-game server 4 receives the game connection signal S1, the processing unit 41 is triggered to identify an identification information of the user 200.

The processing unit 41 identifies the identification information of the user 200 according to at least one user identification information provided by the identification database 422. After the user 200 passes through the identification, the user 200 can perform an interactive operation with the web-game server 4. The user 200 can operates the input unit 13 to select at least one of the main programs (e.g. the main program 4211) stored in the game database 421, and the selected main program 4211 is displayed in the game window 122 of the display 12 for viewing.

Then, the user 200 controls the cursor C to select at least one character element R1, and controls the character element R1 through the input unit 13, so as to continue the interactive operation with the web-game server 4, and the detecting unit 44 is used to detect whether the interactive operation is ongoing. When the detecting unit 44 detects that the interactive operation is disrupted, the processing unit 41 continues executing the character element R1, and records a corresponding event that leads to the interaction disruption into the storage unit 42. Meanwhile, the RTC 451 immediately records a real time of the interaction disruption, and the time counter 452 accumulates the disruption time.

After the user electronic device 1 is reconnected to the web-game server 4 through the Internet 21, and passes through the user information identification, the processing unit 41 determines that the user 200 has the unaccomplished interactive operation. Now, the processing unit 41 confirms that the record of the corresponding event that leads to the interaction disruption is not complied with intentional event data stored in the storage unit 42.

In the present invention, preferably, the processing unit 41 determines that the intentional event is occurred upon shutting down the execution program 141 or the browser (not shown) of the user electronic device 1. For example, the intentional event comprises a situation that the user 200 directly shuts down the execution program 141 or directly closes the browser (not shown) during the interactive operation (i.s. the user 200 actively disrupts the interactive operation).

Then, the processing unit 41 reconfirms that the accumulated disruption time of the user electronic device 1 is less than a timeout threshold through the time counter 452. After the above determination is completed, the processing unit 41 displays a prompt message (not shown) on the game window 122 to notify the user 200 to continue the unaccomplished interactive operation.

When the user 200 continues the interactive operation, the processing unit 41 stops executing the character element R1. Meanwhile, the user 200 starts to control the character element R1 through the input unit 13, so as to continue the interactive operation.

In the present invention, preferably, the user electronic device 1 is one of a personal computer (PC), a notebook (NB) computer, a personal digital assistant (PDA), a mobile phone and a multimedia Internet device (MID).

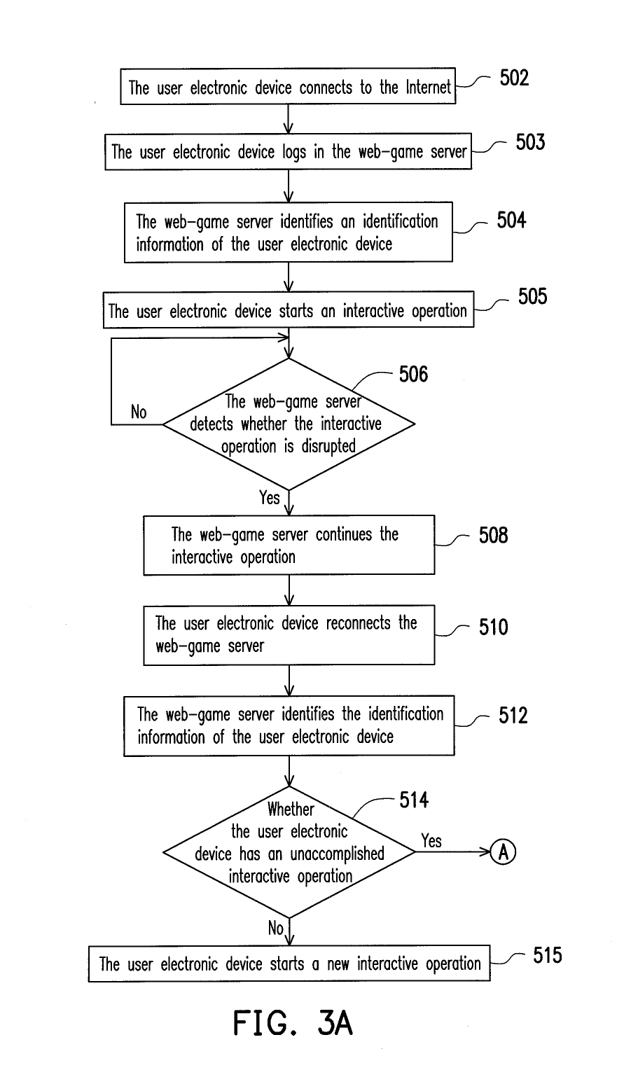

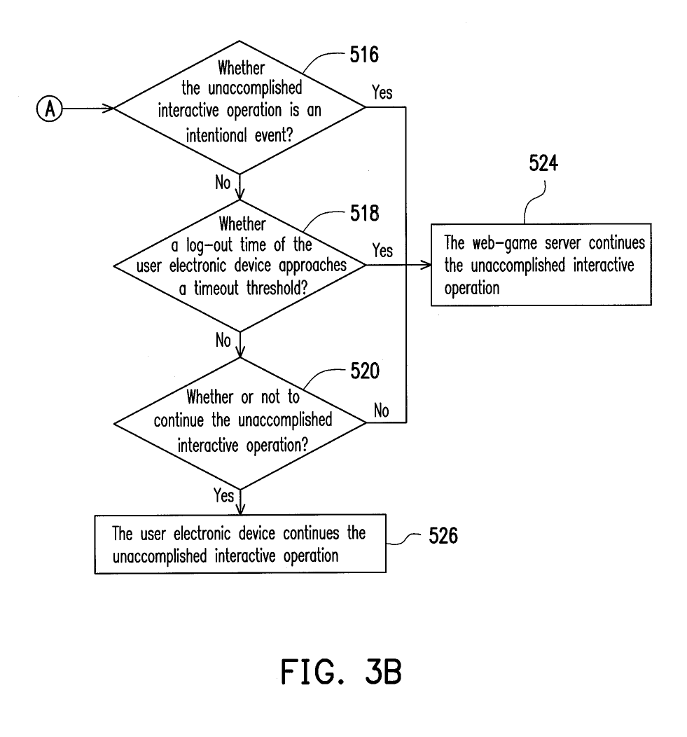

To further convey the spirit of the present invention, a simple flowchart is concluded according to the techniques disclosed by the embodiments of the present invention, so as to facilitate those skilled in the art further understanding the techniques of the present invention. Referring to FIG. 3A and FIG. 3B, FIGS. 3A and 3B are simple flowcharts illustrating an implementation method the present invention. Referring to FIG. 1 and FIGS. 3A and 3B, as shown in FIG. 3A, the user electronic device 1 connects to the Internet 21 (step 502), and logs in the web-game server 4 according to the operation of using the input unit 13 by the user 200 (step 503), and the web-game server 4 identifies an identification information of the user electronic device 1 (step 504).

The user 200 uses the user electronic device 1 to start an interactive operation to execute the character element R1 (step 505). Meanwhile, the detecting unit 44 of the web-game server4 continuously detects whether the interactive operation is disrupted (step 506). If the interactive operation of the user 200 is disrupted, the web-game server 4 takes over the interactive operation and executes the character element R1 after detecting that the interactive operation is disrupted (step 508). The user electronic device 1 reconnects the web-game server 4 through the Internet 21 (step 510), and the web-game server 4 identifies the identification information of the user electronic device 1 (step 512).

After the user electronic device 1 passes through the identification, the web-game server 4 determines whether the user electronic device 1 has an unaccomplished interactive operation (step 514). If the web-game server 4 determines that the user electronic device 1 does not have the unaccomplished interactive operation, the user electronic device 1 starts a new interactive operation (step 515).

If the web-game server 4 determines that the user electronic device 1 has the unaccomplished interactive operation, a step A is executed (referring to FIG. 3B), by which the web-game server 4 further determines whether the unaccomplished interactive operation is an intentional event (step 516). If the web-game server 4 determines that the unaccomplished interactive operation is the intentional event, the web-game server 4 takes over the unaccomplished interactive operation and executes the character element R1 (step 524).

If the web-game server 4 determines that the unaccomplished interactive operation is not the intentional event, the web-game server 4 determines whether a log-out time of the user electronic device 1 approaches a timeout threshold (step 518). If the web-game server 4 determines that the log-out time of the user electronic device 1 approaches the timeout threshold, the web-game server 4 takes over the unaccomplished interactive operation and executes the character element R1 (step 524).

If the web-game server 4 determines that the log-out time of the user electronic device 1 does not approach the timeout threshold, the web-game server 4 displays a prompt message on the game window 122 to remind the user 200 of the user electronic device 1 to determine whether or not to continue the unaccomplished interactive operation and execute the character element R1 (step 520). If the user 200 determines to abort the unaccomplished interactive operation, the web-game server 4 continues the unaccomplished interactive operation and executes the character element R1 (step 524) or stops executing the character element R1.

If the user 200 determines to continue the unaccomplished interactive operation, the web-game server 4 stops controlling the character element R1 in the interactive operation, and the user 200 continues the unaccomplished interactive operation and controls the character element R1 by operating the user electronic device 1 (step 526).

According to the above descriptions, after the user electronic device 1 is successfully reconnected to the web-game server 4, the web-game server 4 permits the user electronic device 1 to continue the unaccomplished interactive operation and execute the character element R1 after determining that the user electronic device 1 is indeed reconnected to the web-game within the timeout threshold, and is indeed unexpectedly withdrawn from the web-game. According to the above method, a loss of money and intangible assets caused be unstable web connection can be greatly reduced, so as to protect the user's right and interest.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A web-game server, communicated with at least one user electronic device through a web and comprising:
a transmission unit, communicated with the user electronic device through the web, for transferring or receiving at least one data;
a storage unit, for storing a main program of a web-game and at least one intentional event, wherein the main program comprises at least one character element;
a processing unit, electrically connected to the storage unit, for executing the main program and performing an interactive operation with the user electronic device in response to the data received from the user electronic device;
a detecting unit, electrically connected to the processing unit for detecting whether the interactive operation is disrupted, and enabling the processing unit to continue executing the character element and recording a corresponding event of disruption of the interactive operation when the interactive operation is disrupted; and
a time counting module, electrically connected to the processing unit, for determining an accumulated disruption time of the interactive operation in collaboration with the detecting unit,
wherein when the user electronic device reactivates the interactive operation to execute the character element after the interactive operation is disrupted, the processing unit permits the user electronic device to continue executing the character element if the processing unit determines that corresponding event is not complied with the intentional event and determines that the accumulated disruption time is less than a timeout threshold.

2. The web-game server as claimed in claim 1, wherein the user electronic device comprises:
an input unit, provided to a user for inputting at least one command to execute the interactive operation;
a user processing unit, electrically connected to the input unit for executing the command; and
a user transmission unit, electrically connected to the user processing unit for transmitting the data to the web.

3. The web-game server as claimed in claim 2, wherein the user electronic device further comprises a display electrically connected to the user processing unit for displaying the character element of the main program.

4. The web-game server as claimed in claim 2, wherein the user electronic device further comprises a user storage unit electrically connected to the user processing unit, wherein the user storage unit comprises an execution program for implementing the interactive operation with the web-game server.

5. The web-game server as claimed in claim 4, wherein after installing the execution program, the user electronic device implements the interactive operation with the web-game server and executes the character element, and when the detecting unit detects that the interactive operation is disrupted, the processing unit determines that the intentional event is occurred upon shutting down the execution program of the user electronic device.

6. The web-game server as claimed in claim 1, wherein the intentional event comprises a situation that a user actively disrupts the interactive operation.

7. The web-game server as claimed in claim 6, wherein the user electronic device implements the interactive operation with the web-game server and executes the character element through a browser, and when the detecting unit detects that the interactive operation is disrupted, the processing unit determines that the intentional event is occurred upon shutting down the browser of the user electronic device.

8. The web-game server as claimed in claim 1, wherein the storage unit further comprises an identification database, and the identification database comprises at least one user identification information for providing the processing unit to identify an identification information of the user.

9. The web-game server as claimed in claim 1, wherein the time counting module further comprises a real time counter, and the real time counter is used for recording a disruption time when the detecting unit determines that the user electronic device disrupts the interactive operation.

10. The web-game server as claimed in claim 1, wherein the time counting module further comprises a time counter, and the time counter is used for accumulating the accumulated disruption time from when the detecting unit determines that the user electronic device disrupts the interactive operation.

11. A method for re-connecting an unexpectedly off-line web-game, for communicating a web-game server with a user electronic device through a web, and enabling the user electronic device to continue an interactive operation after the interactive operation between the user electronic device and the web-game server is disrupted, and the method comprising:
(a) using the web-game server to detect whether the interactive operation is disrupted;
(b) waiting the user electronic device to successfully reconnect the web-game server when the interactive operation is disrupted;
(c) using the web-game server to determine whether the user electronic device has an unaccomplished interactive operation when the user electronic device is successfully reconnected to the web-game server;
(d) using the web-game server to determine whether the unaccomplished interactive operation is an intentional event when it is determined that the user electronic device has the unaccomplished interactive operation;
(e) using the web-game server to determine whether a log-out time of the user electronic device approaches a timeout threshold when the unaccomplished interactive operation is not the intentional event; and
(f) allowing the user electronic device to continue the unaccomplished interactive operation when the log-out time of the user electronic device does not approach the timeout threshold.

12. The method for re-connecting the unexpectedly off-line web-game as claimed in claim 11, wherein the step of (a) comprises:
using a detecting unit to detect whether the interactive operation is disrupted; and
when the detecting unit determines that the interactive operation is disrupted, the web-game server continues the interactive operation.

13. The method for re-connecting the unexpectedly off-line web-game as claimed in claim 11, wherein the step (b) further comprises:
using the web-game server to identify an identification information of the user electronic device.

14. The method for re-connecting the unexpectedly off-line web-game as claimed in claim 13, wherein the web-game server accesses an identification database and identifies the identification information of the user electronic device.

15. The method for re-connecting the unexpectedly off-line web-game as claimed in claim 11, wherein the step (c) further comprises:
using the web-game server to determine whether the user electronic device has the unaccomplished interactive operation.

16. The method for re-connecting the unexpectedly off-line web-game as claimed in claim 11, wherein in the step (d), the intentional event comprises a situation that a user actively disrupts the interactive operation.

17. The method for re-connecting the unexpectedly off-line web-game as claimed in claim 16, wherein the intentional event comprises that the user electronic device actively shuts down a main program in the interactive operation.

18. The method for re-connecting the unexpectedly off-line web-game as claimed in claim 16, wherein the intentional event comprises that the user electronic device actively shuts down a browser in the interactive operation.

19. The method for re-connecting the unexpectedly off-line web-game as claimed in claim 11, wherein in the step (e), the web-game serve determines whether the user electronic device logs out for more than the timeout threshold through a time counting module.
